(19) United States
(12) Patent Application Publication
(10) Pub. No.: US 2008/0013236 A1
(43) Pub. Date: Jan. 17, 2008

(54) Passive switching capacitor network auxiliary voltage source for off-line IC chip and additional circuits

(76) Inventor: Da Feng Weng, Cupertino, CA (US)

Correspondence Address: Da Feng Weng, 21900 Rucker Dr., Cupertino, CA, 95014, US

(21) Appl. No.: 11/487,345

(22) Filed: Jul. 17, 2006

(51) Int. Cl. H02H 9/04

(52) U.S. Cl. 361/91.1

(57) ABSTRACT

An invention of switching capacitor network auxiliary voltage source for IC chip solution and additional function circuits is provided. The solution can convert the high DC bus voltage into the low DC voltage in low cost and in high efficiency. The auxiliary voltage is independent of the power converter system duty-cycle. The additional function circuits can make the off-line IC chip drive and control high voltage off-line converter

### BACKGROUND OF THE INVENTION

The present invention relates to the auxiliary voltage source for the off-line IC chip and additional circuit. More particularly, the invention relates to a new concept to generate auxiliary voltage sources for the off-line IC chip.

For off-line power supply application, due to a high DC bus after AC/DC power stage, it is very important to offer an off-line IC chip a suitable auxiliary voltage source V_{cc}, that is, to convert the high DC bus voltage into low DC voltage in low cost and high efficiency.

In existed auxiliary voltage source generating solution, they can be classified as low voltage solution and high voltage solution. In the low voltage solution, there is an additional active device to suffer the high DC bus voltage and an additional auxiliary winding to set up a suitable auxiliary voltage source for the off-line IC chip. In this solution, the auxiliary voltage will be variable with the load or the output voltage due to a duty-cycle issue. The benefit of the solution is that, in the off-line IC chip, there is no high voltage processor required and the chip can be small in size and low in cost. But the total solution cost is still higher due to the additional active device and auxiliary winding. In the high voltage solution, the off-line IC chip has the high voltage processor and the off-line IC chip can directly connect to DC bus rail. The off-line IC chip has a function block to convert the high DC bus voltage into the low DC voltage as the IC chip auxiliary voltage source. The benefit of the solution is simple in the solution and independent of the duty-cycle issue. But the cost of the solution is high due to the high voltage processor and there is a thermal issue with the IC chip due to a high DC bus voltage drop on the chip.

For the low cost solution of the off-line IC chip auxiliary voltage source, it is required that the whole chip with the auxiliary voltage source can be implemented in the regular low voltage processor without additional active device or no high voltage processor with no thermal issue in the total solution, and the auxiliary voltage source is independent of the duty-cycle and load. The present invention is to present a simple solution for the IC chip auxiliary voltage source. It is low cost and independent of the duty-cycle.

Besides the auxiliary voltage source, off-line IC needs several additional functions to build up the whole off-line system, e.g. over-voltage protection, drive low side MOSFET synchronized rectifier function for high efficiency. The additional functions are very important for high power LED general lighting application.

### SUMMARY OF THE INVENTION

The present invention discloses a novel passive switching capacitor auxiliary voltage source solution for the off-line IC chip and additional circuit. In the solution, the invention is composed of three parts. The first is the auxiliary voltage source with passive switching capacitor concept. The second is for over voltage protection function. The third is for low side MOSFET driving. Based on the invention, off-line chip can be implemented in the regular low voltage processor and it can be used to control high voltage application with low current high voltage external diodes.

In the auxiliary voltage source of off-line power converter circuit, passive switching capacitor network are used to convert the DC bus voltage into a low DC voltage and regulate the low DC voltage as a suitable auxiliary voltage for the off-line IC chip. It is the passive switching capacitor circuit that it is low in cost. Due to the switching capacitor operation concept, there is no duty-cycle issue. The present invention fully utilizes the characteristics of the switching power converter to implement the switching capacitor concept.

The solution block diagram is shown in FIG. 1. It is composed of a passive switching capacitor network block and a feedback winding of switching magnetic core component. The passive switching capacitor network block and a feedback winding of switching magnetic core component or a capacitor couple network are used to convert the high DC bus voltage into a low DC output voltage, and the low DC output voltage is used as off-line IC chip auxiliary voltage source. In the auxiliary voltage source, the feedback winding or capacitor couple network offers a square waveform in designed amplitude and in the switching frequency of the switching power supply. It is the square waveform that makes the switching capacitor to charge and discharge and generates the required auxiliary voltage for the off-line IC chip.

In the switching capacitor operation concept, all energy transfer is based on how high the dv/dt is on the switching capacitors, otherwise saying, any energy transfer is taking place at the exact instant of switching due to high dv/dt on the switching capacitors during the switching capacitors' charging or discharging period. After that instant, as long as the switching capacitors have been charged or discharged completely, due to low dv/dt on the switching capacitors, the transferred energy is almost zero. Based on the switching capacitor operation concept, for the auxiliary voltage source circuit, the energy transfer rate is determined by the amplitude of the square waveform from the feedback winding, the switching frequency and the values of the switching capacitors and is independent of the duty-cycle of the square waveform.

In off-line buck circuit shown in FIG. 7, the off-line chip controls high side MOSFET. It is very important to sense and monitor the output voltage. Based on the sensed signal from the output voltage, the off-line chip will regulate the output voltage or take over voltage protection. In the buck circuit, the ground of off-line chip isn't the ground of the output. It needs to utilize the characteristic of buck circuit to sense the output voltage. FIG. 8 shows a detail application circuit. A switching network is used to sample and monitor the output voltage and the detecting signal is independent of the duty-cycle of PWM switching pulse. In the detecting circuit, the off-line chip doesn't suffer the high voltage between high side and low side. An external low current high voltage diode will suffer the high voltage.

In off-line buck circuit, for high output current application, in order to obtain the higher efficiency, it is a good solution to replace the low side diode with synchronized MOSFET. As MOSFET turns on, the voltage dropping on MOSFET is the product of Rds(on) and the current through the MOSFET. As shown in FIG. 7, the off-line chip control high side MOSFET, it is necessary to figure out the easiest way to control and drive the low side MOSFET based on the characteristic of buck circuit. FIG. 9 shows a detail application circuit. The low side MOSFET can be driven and controlled with the off-line chip. In the control and driving circuit, the off-line chip doesn't suffer the high voltage between high side and low side. An external low current high voltage diode will suffer the high voltage. It is low in cost.

### BRIEF DESCRIPTION OF THE DRAWINGS

FIG. 1 is a general switching capacitor network auxiliary voltage source system for the offline DC/DC converter with the control IC block diagram of the present invention.

FIG. 2 is one of detailed embodiment of the general switching capacitor network auxiliary voltage source with a feedback winding for the off-line IC chip block diagram of the present invention;

FIG. 3 is one of practical embodiment of the general switching capacitor network auxiliary voltage source with a capacitor couple network from a switching voltage source for the off-line IC chip block diagram of the present invention;

FIG. 4 is other detail practical embodiment with an inserted inductor

FIG. 5 is the whole self-start process waveforms of FIG. 2 circuit.

FIG. 6 is the detail waveforms of FIG. 2 circuit.

FIG. 7 is step down converter with off-line chip control high side MOSFET.

FIG. 8 is detail sampling circuit to detect the output voltage.

FIG. 9 is step down synchronous converter driver.

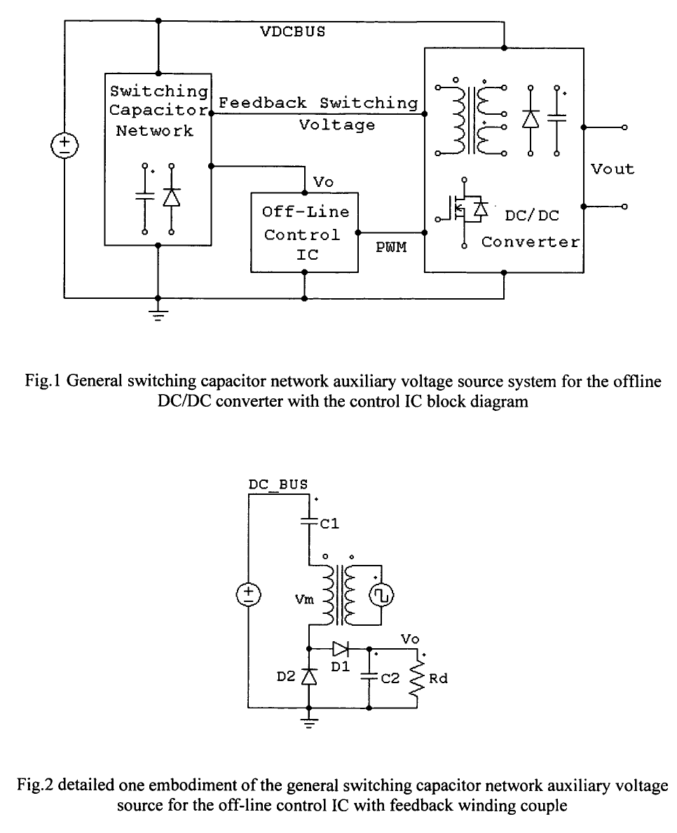

### DETAIL DESCRIPTION OF THE INVENTION

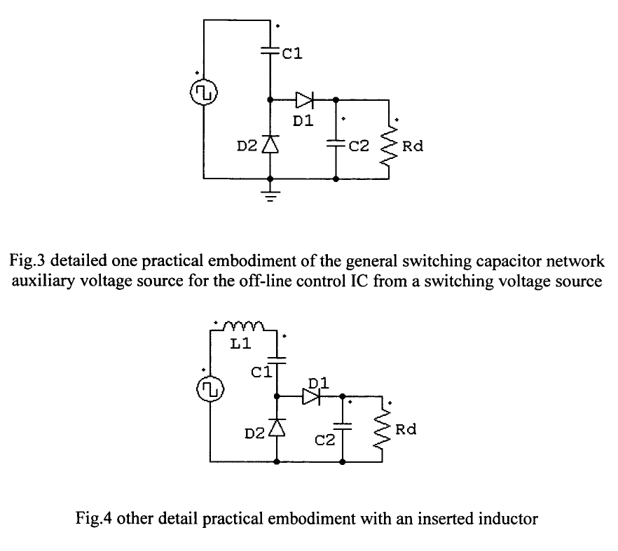

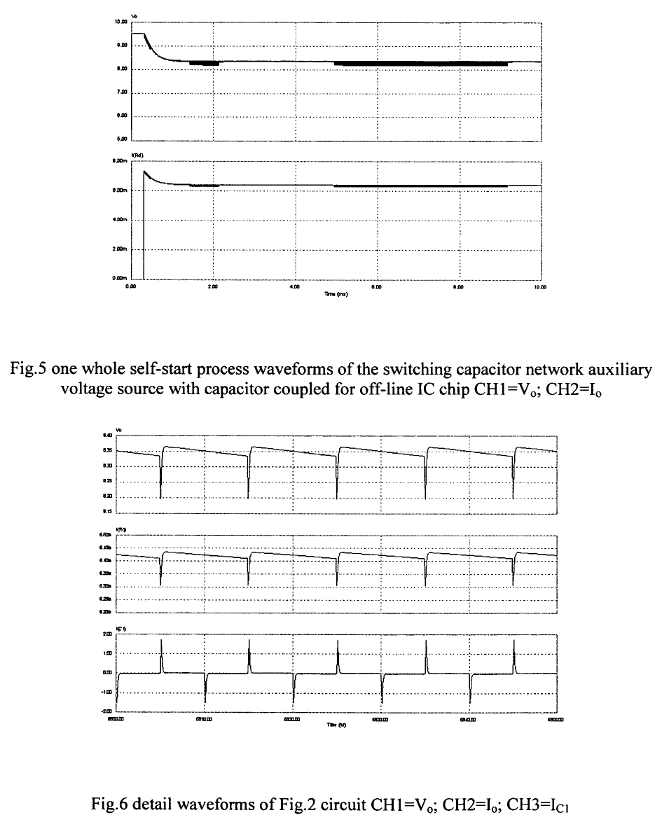

FIG. 2 shows one detail embodiment of the invention scheme block diagram. In the detail block diagram, there are three blocks: the feedback winding, switching capacitor network and the equivalent load.

As shown in FIG. 2, if the amplitude of the switching waveform from the feedback winding is zero and the equivalent load current is zero, the high DC bus voltage is divided by two switching capacitors C1 and C2. The output voltage Vₒ is:

$${V}_{O} = {V}_{IN} \cdot \frac{{C}_{1}}{{C}_{2} + {C}_{1}} \qquad ( 1 )$$

As the equivalent load current is over zero, the output voltage will decrease because the capacitor C₁ is charged and the capacitor C₂ is discharged. It is clear that if, under the equivalent load current condition, the capacitor C₁ can be discharged to compensate the capacitor C₂ discharging charge, the output voltage can keep the value shown in EQ (1). The switching waveform from the feedback winding is used to discharge the capacitor C₁ and makes the output voltage in an accepted range. For easy explanation, supposed that, the switching waveform is stepped from zero to Vₘ. As shown in FIG. 2, the switching waveform Vm is coupled through a feedback winding. The amplitude of the Vm is adjusted with the ratio of the turns. The voltage on the capacitor C₁ is discharged from (Vᵢₙ−Vₒ) to (Vᵢₙ−Vₘ) through the diode D₂. The discharged charge is feedback to the DC bus voltage Vᵢₙ. Due to high dv/dt, the discharge is quickly finished. As the switching waveform steps back to zero, the capacitor C₁ is charged from (Vᵢₙ−Vₘ) to (Vᵢₙ−Vₒ) through the diode D₁ and the capacitor C₂. Due to high dv/dt, the charge is quickly finished. It is the charging charge that keeps the output voltage, that is, voltage on C₂ as shown in EQ 1.

From the operation principle, the condition to make the capacitor C₁ discharge is to make the diode D₂ turn on. The condition for the diode D₂ turn-on is that Vₘ must be over Vₒ. The switching capacitor operation condition is Vₘ≧Vₒ, otherwise, there is no switching capacitor discharge operation, and the output voltage will decrease. For a fixed Vₘ, the output voltage Vₒ is a variable with the load. It is clear that as the load current is decreased from the maximum load current, due to the fixed Vₘ, the power transferred from the switching capacitor is higher than the power dissipation of the load. It is power unbalance between the transferred power and the load dissipation power that makes the output voltage Vₒ of the auxiliary voltage source increase. As the amplitude of Vₒ will be closed to the fixed Vₘ and even higher than Vₘ, the switching capacitor operation condition isn't set up, there is no switching capacitor discharge operation to transfer the input power. As the input transferred power is less than the load dissipation power, due to the power unbalance, the output voltage Vₒ of the auxiliary voltage source decreases. It is the characteristic of the operation that makes the auxiliary voltage have an automatic load regulation function to keep the output voltage in an accept range as long as the maximum discharging charge of the capacitor C2 is less than the charging charge of the capacitor C1.

It is the load regulation function that makes the passive switching capacitor circuit design much easy. As we know the amplitude Vₘ of switching waveform, the switching frequency fₛ, the output voltage Vₒ and the switching capacitor C₁, the charging current I_{charging} is: (as Vₘ>Vₒ)

I_{Charging}=C₁·(Vₘ−Vₒ)·fₛ (2)

In equation (2), it shows that as Vₘ is closed to Vₒ, the input current I_{charging} of the switching capacitor network is decreased. For a designed Vₘ, Vₒ, C₁ and fₛ, equation (2) gives the maximum output current of the switching capacitor network. Based on equation (2), the maximum load current should be less than the maximum output current.

The value of the switching capacitor C₂ is determined by the initial start up voltage. From equation (1), for no load current condition, the voltage on the switching capacitor C₂ is a fraction of Vᵢₙ in the ratio of C₁ and C₂. In most of control ICs, there is a UVLO function to enable or disable IC operation function, that is, as the output voltage Vₒ is less than a certain fixed level VT1, IC is disable and as the output voltage Vₒ is higher than a certain fixed level VT2, IC is enable, (In general, VT2>VT1). The value of the switching capacitor C2 is to make the output voltage is higher than VT2:

$$\begin{matrix}VT 2 \leq \frac{{C}_{1}}{{C}_{1} + {C}_{2}} \cdot {V}_{IN} & ( 3 ) \\ {V}_{O} > VT 1 & ( 4 )\end{matrix}$$

### From equations (2), (3) and (4), it is easy to design values of two switching capacitors C₁ and C₂. As shown in FIG. 2, the invention circuit is very simple and low cost to generate an auxiliary voltage source for off-line control IC.

FIG. 3 shows how a switching voltage source directly generates an adjustable DC voltage source for off-line control IC. For higher efficiency and limit the amplitude of the pulse current, the small inductor is inserted and the circuit is shown in FIG. 4. The amplitude of the pulse current I_{M} is: (V_{S} is the amplitude of the switching voltage source)

$${I}_{M} = \frac{{V}_{S}}{\sqrt{\frac{{L}_{1}}{{C}_{1}}}} \qquad ( 5 )$$

In this kind of switching capacitor circuit, there is no active switch to involve switching capacitor function. The characteristic of the switching converter, that is, switching voltage waveform, is fully utilized to drive the passive switching capacitor circuit. In the detail implement circuit, if the switching voltage source is coupled through transformer, or couple inductor winding, due to voltage-second of the transformer or couple inductor, the coupled switching voltage is an AC voltage and the instant voltage steps from a negative voltage Vₘ₋ to a positive voltage Vₘ₊. In design equation (2), Vₘ should be peak to peak of the coupled AC voltage. This kind of switching capacitor network can apply to the most of off-line control IC with UVLO function.

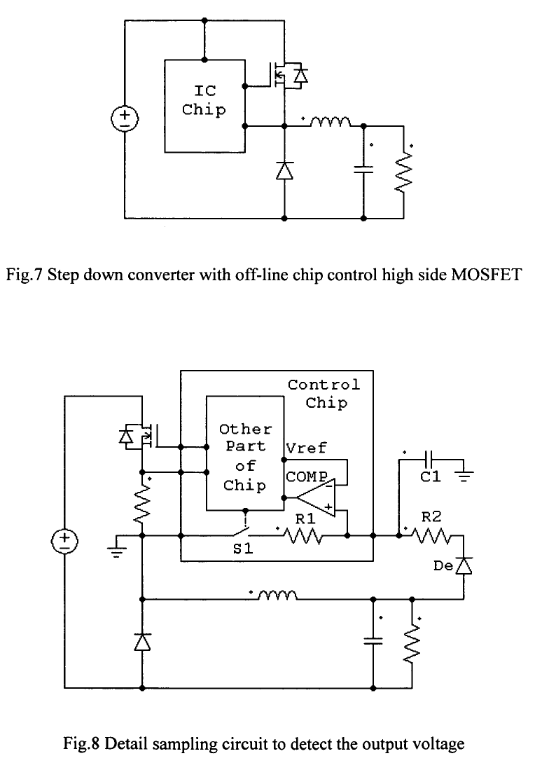

For step down buck converter, it is easy to control the high side power switch with the off-line control chip as shown in FIG. 7. The auxiliary voltage source for the off-line chip can be generated with the simple circuit shown in FIG. 3 or FIG. 4. For this kind of power system, it is necessary to control or monitor the output voltage. As shown in FIG. 7, the ground of the off-line chip is floating with the output ground. It is impossible to directly detect the output voltage with a simple voltage divider. Based on the buck circuit operating principle, as the high side power switch turns off, the low side diode will turn on to continue the inductor current. It is the low side diode turn-on interval that the ground of the off-line chip is connected with the output ground. It is clear that if the off-line chip can sample the output voltage during the low side diode turn-on interval, the off-line chip can used the sampled information to regulate or take over voltage protection.

The detail sampling circuit is shown in FIG. 8. The output voltage detecting circuit is composed of S1, R1, R2, C1 and De. S1 and R1 are in the off-line chip. R2, C1 and De are external components. The operation principle of the sample circuit is as follows. In the buck circuit, as the off-line chip turns off the high side power switch, due to inductor current, the low side diode turns on automatically. It is the low side diode turn-on that the ground of the off-line chip is connected with the output ground. At the same time, S1 in the off-line chip turns on and the output voltage is divided with R1 and R2 through the external diode De. The sample capacitor C1 is connected with the ground of off-line chip and the joint node of R1 and R2. C1 samples the voltage on R1 as S1 turn-on. As the off-line chip turns on the high side power switch, S2 is turned off. It makes the ground of the off-line chip disconnect with the ground of the output and the ground of the off-line chip is connected with the input voltage terminal through the high side power switch. Since the potential of the ground of the off-line chip is higher than one of the output terminal, it makes the external diode De block. It is turn-off of both S1 and De that builds up a sample function circuit with C1. The comparator in the off-line chip can compare the voltage on C1 with the reference voltage in the chip to regulate or take over voltage protection. The sampling circuit is fully utilizing the operation principle of the buck converter to implement the sample function. In the circuit, the external diode suffers the high block voltage between the input voltage and output voltage. It is the external diode that there is no any high voltage dropping on the off-line chip. The turn-on time constant τₜᵤᵣₙ₋ₒₙ of the sampling circuit is as follows:

$${τ}_{turn \text{-} on} = {C}_{1} \cdot \frac{{R}_{1} \cdot {R}_{2}}{{R}_{1} + {R}_{2}} \qquad ( 5 )$$

In general, the turn-on time constant τₜᵤᵣₙ₋ₒₙ is less than the minimum of the low side diode turn-on time to make sure that the voltage on C1 is in steady state before the end of sampling. The voltage VC1 on C1 is determined with R1, R2 and the output voltage Vo.

$${V}_{C 1} = {V}_{O} \cdot \frac{{R}_{1}}{{R}_{1} + {R}_{2}} \qquad ( 6 )$$

In buck circuit application, as the output load current increases, synchronous rectifier can further increase the whole system efficiency. The technology has been widely used in low voltage high current application, e.g. VRM core converter. In Buck synchronous rectifier circuit, the low side diode of the buck is replaced with a power MOSFET. As the power MOSFET turns on, the voltage dropped on the low side switch decreases from the forward voltage dropped on the low side diode to the product of Rds(on) and the current through the power MOSFET. As long as the Rds(on) is chosen low, the voltage dropped on the power MOSFET is low and the system efficiency is high.

It is the power MOSFET that needs to be driven. For low input voltage on line application, it isn't hard to drive the high and low power MOSFETs with a high side and low side driver. For high input voltage off-line application, it is an issue how to drive the high and low sides'power MOSFETs. In general, the driver chip needs high voltage processor and it is high cost solution.

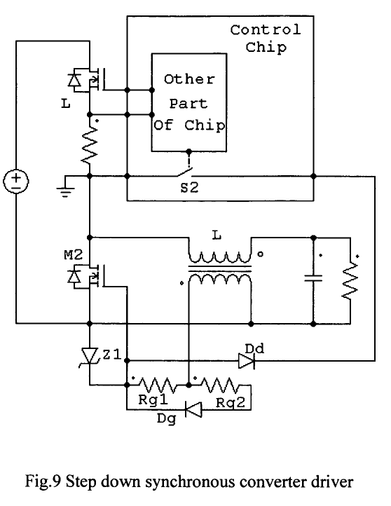

FIG. 9 shows an invention synchronous rectifier converter driver circuit. It utilized the characteristic of the buck circuit with an additional winding to turn on and drive the low side power MOSFET M2. The low side power MOSFET M2 can be turned off with the diode Dd, the off-line control chip and the additional winding. The operation principle is the driver circuit is as follows.

As the off-line chip turns off the high side power MOSFET M1, due to the buck inductor current continue, the low side power MOSFET M2 body diode turns on automatically. It is the body diode turn-on that makes the voltage on the buck inductor equal to the output voltage Vo. The additional couple winding of the buck inductor outputs driving voltage through a resistor Rg1, Rg2, diode Dg and Zener diode Z1 to the low side power MOSFET M2. M2 is turned on and the voltage dropped on M2 is low. Zener diode Z1 is used to limit the maximum voltage on the gate of M2. Before the off-line chip turns on the high side power MOSFET, the off-line chip turns the insides switch S2. It is S2 turn-on that the gate voltage of M2 is discharged to zero through Dd, S2 and the low side power MOSFET M2. The low side power MOSFET turns off and the body diode turns on to continue the buck inductor current. As the off-line chip turns on the high side power MOSFET, the low side body diode is turned off and the voltage on the buck inductor changes from -Vo to Vin-Vo. The voltage from the additional couple winding is changed from positive to negative and the negative voltage turns on the zener diode as a forward diode. It is the forward diode turn-on that makes sure the low side power MOSFET turn-off. In the circuit, the diode Dd is used to suffer the voltage between the high voltage input and the ground. The insides switch S2 only suffers the Zener diode's voltage V_{Z1}. It is clear that the off-line chip doesn't need to suffer high voltage in both turn-on and off status. In FIG. 9, Rg1, Rg2 and Dg are used to build up a nonlinear resistor network.

In the invention, with additional auxiliary circuits and low-current high-voltage diodes, the low voltage processor off-line IC chip can be easy used to drive and control high voltage off-line converter. Due to low voltage processor IC and low-current high-voltage diodes, the total solution of the off-line converter is low in cost.

What is claimed is:

1. Switching capacitor network auxiliary voltage source for the IC chip solution comprising:
Switching capacitor network block for converting the high DC bus voltage into a suitable low DC input voltage; and
feedback voltage from the switching power supply.

2. Switching capacitor network auxiliary voltage source for IC chip solution claim 1, wherein switching capacitor can be a simple passive switching capacitor network and be implemented with more complicate passive switching capacitor circuit.

3. Switching capacitor network auxiliary voltage source for IC chip solution claim 1, wherein feedback voltage from the switching power supply can be coupled by the magnetic field or by charge couple.

4. Switching capacitor network auxiliary voltage source for IC chip solution claim 3, wherein magnetic field couple can be through a transformer or couple inductor winding.

5. Switching capacitor network auxiliary voltage source for IC chip solution claim 3, wherein charge couple can be through a capacitor.

6. For step down converter, the monitor circuit of the output voltage from the floating high side control chip comprising:
Device to suffer high voltage and turn on or off automatically as the high side MOSFET turn-on or off, and
Voltage divider; and sampling hold circuit.

7. For step down synchronized converter, the driver of low side MOSFET comprising:
Device to suffer high voltage and turn off the low side MOSFET; and
Couple circuit to drive the low side MOSFET; and
Clamping circuit to limit the gate-source voltage of the low side MOSFET as it turns on and make sure gate-source voltage below threshold of the low side MOSFET as it turns off.
